(19) United States
(12) Patent Application Publication
(10) Pub. No.: US 2011/0208640 A1
(43) Pub. Date: Aug. 25, 2011

(54) TICKETED FUNDS TRANSFERS BETWEEN A BROKERAGE ACCOUNT AND A DEPOSIT ACCOUNT

(75) Inventors: Tomas Ambrose Geoghegan, Summit, NJ (US); Allen George Braithwaite, III, Princeton, NJ (US); George Semen, JR., Califon, NJ (US)

(73) Assignee: BANK OF AMERICA CORPORATION, Charlotte, NC (US)

(21) Appl. No.: 12/709,141

(22) Filed: Feb. 19, 2010

(51) Int. Cl. G06Q 40/00

(52) U.S. Cl. 705/39

(57) ABSTRACT

Systems, apparatuses, and methods may include establishing an omnibus account for conducting financial transactions with a financial institution, establishing a brokerage account for each of a plurality of customers, receiving a plurality of order requests to make transfers of respective customer-specified monetary amounts between a subset of the brokerage accounts and the omnibus account, aggregating the monetary amounts to determine a net monetary amount based on the order requests, generating a payment order based on the net monetary amount, communicating the payment order to the financial institution, and receiving confirmation from the financial institution in response to the payment order to execute the order requests.

### BACKGROUND

A customer may establish a brokerage account with a broker to invest in securities. Brokerage accounts often have idle uninvested cash. Conventionally, this cash may be automatically transferred from the brokerage account to a money market mutual fund (a “money” fund) or to a bank for savings in a money market deposit account or other bank account. These automatic transfers may occur periodically (e.g., daily) and are referred to as “sweeps.” At a later time, when a user purchases a security or otherwise uses their funds, the broker will automatically “sweep” funds out of the depository instrument into cash to cover the debit. Thus, sweep deposits permit the customer to earn a nominal yield on the uninvested cash and to have quick access to their cash. The interest rate paid on sweep deposits, however, may be less than what some customers desire. Other investments may pay a higher yield, but can involve greater financial risk and/or greater liquidity risk and/or less convenience. Many customers value the combined level of convenience, safety and yield offered by the sweeps and leave much of their cash invested in the sweep deposits.

### BRIEF SUMMARY

In light of the foregoing background, the following presents a simplified summary of the present disclosure in order to provide a basic understanding of some example aspects. This summary is not an extensive overview. It is not intended to identify key or critical elements or to delineate the scope of the example embodiments. The following summary merely presents some concepts of the example embodiments in a simplified form as a prelude to the more detailed description provided below.

Aspects of the disclosure address one or more of the issues mentioned above by disclosing systems, apparatuses, and methods may include establishing an omnibus account for conducting financial transactions with a financial institution, establishing a brokerage account for each of a plurality of customers, receiving a plurality of order requests to make transfers of respective customer-specified monetary amounts between a subset of the brokerage accounts and the omnibus account, aggregating the monetary amounts to determine a net monetary amount based on the order requests, generating a payment order based on the net monetary amount, communicating the payment order to the financial institution, and receiving confirmation from the financial institution in response to the payment order to execute the order requests.

Aspects of the disclosure may be provided in one or more tangible computer-readable medium storing computer-executable instructions that, when executed by one or more processors, cause a computer or other apparatus to perform one or more of the operations described herein.

### BRIEF DESCRIPTION OF THE DRAWINGS

The present disclosure is illustrated by way of example and is not limited in the accompanying figures in which like reference numerals indicate similar elements and in which:

FIG. 1 illustrates an example block diagram of a system for providing a ticketed funds transfers in accordance with illustrative embodiments of the present disclosure.

FIG. 2 illustrates an example architecture implementation of computers and servers in accordance with illustrative embodiments of the present disclosure.

FIG. 3 illustrates an example signaling diagram of communications between a financial institution server, a broker server, and a customer computer in accordance with illustrative embodiments of the present disclosure.

FIG. 4 illustrates an example of a brokerage database implemented at the broker server in accordance with illustrative embodiments of the present disclosure.

FIG. 5 illustrates an example of a financial institution database implemented at the financial institution server in accordance with illustrative embodiments of the present disclosure.

FIG. 6 illustrates an example method of processing a ticketed order request in accordance with illustrative embodiments of the present disclosure.

FIG. 7 illustrates an example method of allocating accrued interest to omnibus subaccounts in accordance with illustrative embodiments of the present disclosure.

### DETAILED DESCRIPTION

Example embodiments described herein provide for ticketed funds transfers between a customer's brokerage account and an interest bearing deposit account of a financial institution. The term “ticketed” may refer to the manual deposit order and manual withdrawal request relationship of which funds are transferred between the brokerage account and the deposit account. In a ticketed deposit, a customer may specify an exact amount to transfer from the brokerage account to the deposit account. Similarly, in a ticketed withdrawal, a customer may specify an exact amount to transfer from the deposit account to the brokerage account. A ticketed deposit/withdrawal is similar to how a security is bought and sold using a brokerage account. Depositing funds to the financial institution may be referred to as a ticketing in, and withdrawing funds may be referred to as ticketing out.

The ticketing process is a different way of transferring funds into and out of the deposit account as compared with sweeps of idle uninvested cash. Rather than automatic periodic sweeps of idle uninvested cash from the brokerage account to the deposit account, the customer may specify an exact amount of money for transfer to the deposit account. Conventional sweeps, in contrast, may transfer all remaining uninvested funds from the brokerage account. Also unlike sweep deposits, the funds deposited using ticketed transfer to the deposit account may not be automatically used when a customer purchases a security using their brokerage account. Instead, the customer would have to ticket out to transfer funds from the deposit account to the brokerage account to use the funds from the deposit account to purchase the security if the purchase was not to be funded from another source.

Rather than the broker's customers individually establishing deposit accounts with the financial institution, the broker may set up an omnibus account with one or more financial institutions to conduct the ticketed transactions. Each customer may have a subaccount in the omnibus account. Periodically, the broker may aggregate ticketed deposits/withdrawals from the customers to determine a net change in a balance of the omnibus account. The broker may then communicate the net change to transfer funds between the omnibus account and the financial institution. The omnibus account may permit a group of customers to conveniently invest in interest bearing savings accounts using their brokerage accounts, rather than having to separately set up and maintain a savings account with each financial institution. Thus, customers may use relationships the broker has with one or more financial institutions to set up interest bearing savings accounts and also may benefit by receiving at least some Federal Deposit Insurance Corporation (FDIC) insurance on the deposits.

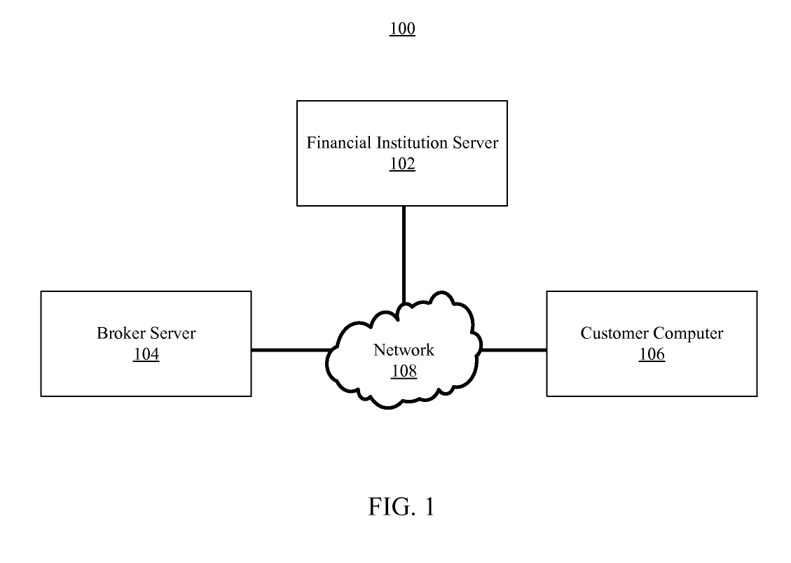

FIG. 1 illustrates an example block diagram of a system 100 for providing ticketed transfers. A financial institution server 102, a broker server 104, and a customer computer 106 may be communicatively coupled via network 108. The network 108 may be a local area network (LAN), a wide area network (WAN), as well as one or more other networks or combinations of networks. It will be appreciated that the network connections shown are illustrative and other means of establishing a communications link between the computers may be used. The existence of any of various well-known protocols such as TCP/IP, Ethernet, FTP, HTTP and the like may be used.

The financial institution server 102 may be a computer server provided by a bank or other entity providing financial services. The broker server 104 may be a computer server associated with a brokerage firm permitting a customer to trade financial instruments (e.g., stocks, bonds, savings accounts, money market funds, etc.). The customer computer 106 may be a home or office computer of an individual, company, or group that has a brokerage account set up with the brokerage firm. The financial institution server 102, the broker server 104, and/or the customer computer 106 may also be mobile terminals, smart phones, etc., including various other components, such as a battery, speaker, and antennas. It is noted that FIG. 1 depicts a single instance of each of the financial institution server 102, the broker server 104, and the customer computer 106; however, the system 100 may include multiple instances of each of these devices. Moreover, the functions described as being performed by these devices may be subdivided or aggregated into more or fewer devices.

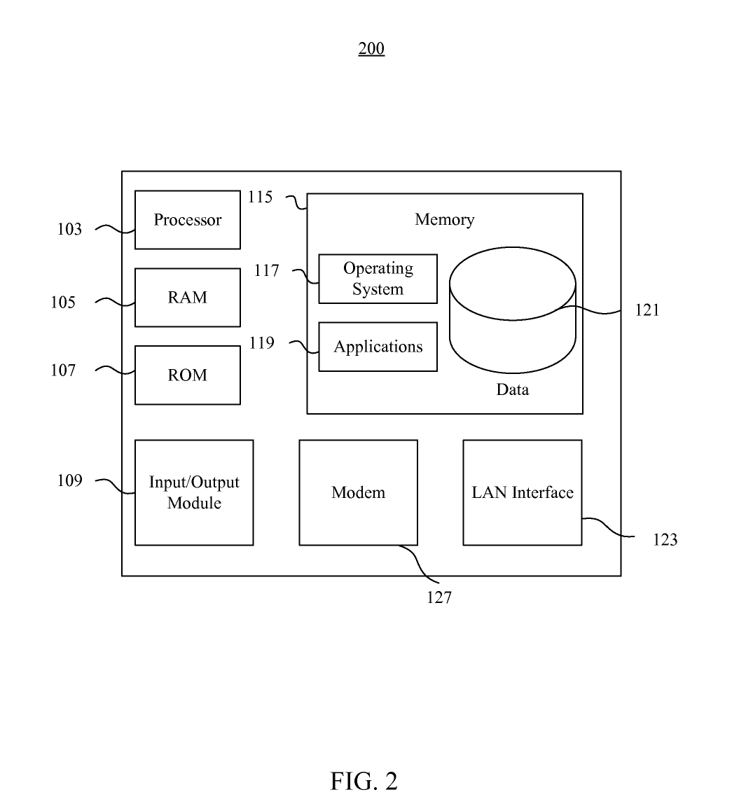

FIG. 2 illustrates an example architecture implementation of the computers and servers depicted in the system 100. Some or all of the architecture of computer 200 described in FIG. 2 may be implemented in each of the financial institution server 102, the broker server 104 and/or the customer computer 106. In an example embodiment, the computer 200 may have a processor 103 for controlling its overall operation and its associated components, including RAM 105, ROM 107, input/output module 109, and memory 115. The computer 200 may operate in a networked environment supporting connections to one or more remote computers using a modem 127 or LAN interface 123. For example, the computer 200 may support network connections to the broker server 104 and the customer computer 106. Processor 103 and its associated components may run a series of computer-readable instructions to cause the computer 200 to perform the operations described herein.

Input/Output (I/O) 109 may include a microphone, keypad, touch screen, and/or stylus through which a user of computer 200 may provide input, and may also include one or more of a speaker for providing audio output and a video display device for providing textual, audiovisual and/or graphical output. Software may be stored within memory 115 and/or storage to provide instructions to processor 103 for performing various functions. For example, memory 115 may store software such as an operating system 117, application programs 119, and an associated database 121.

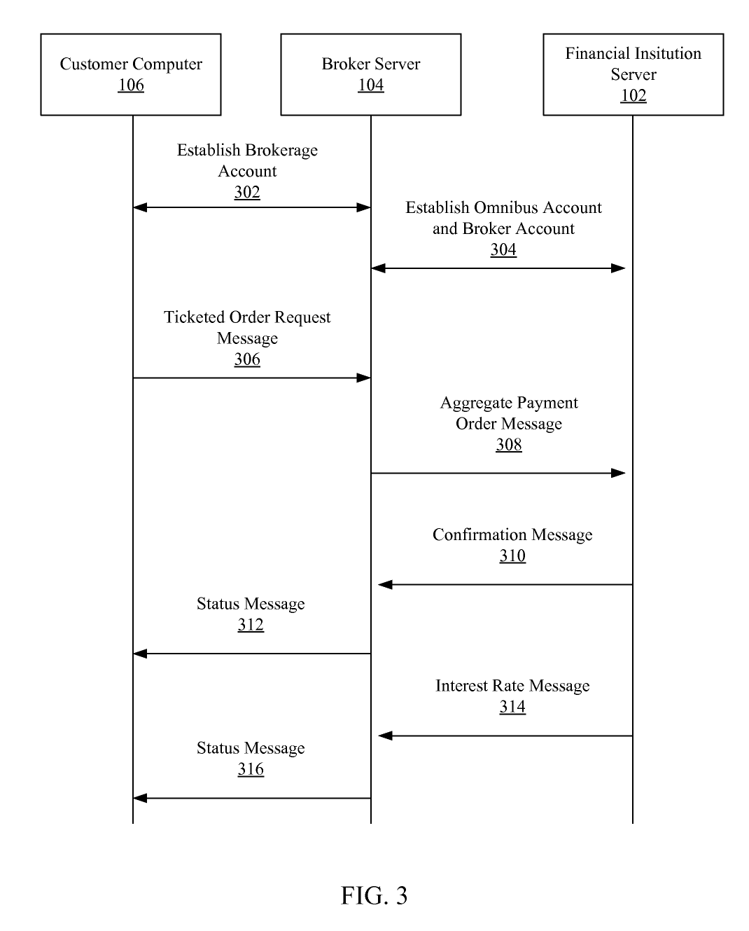

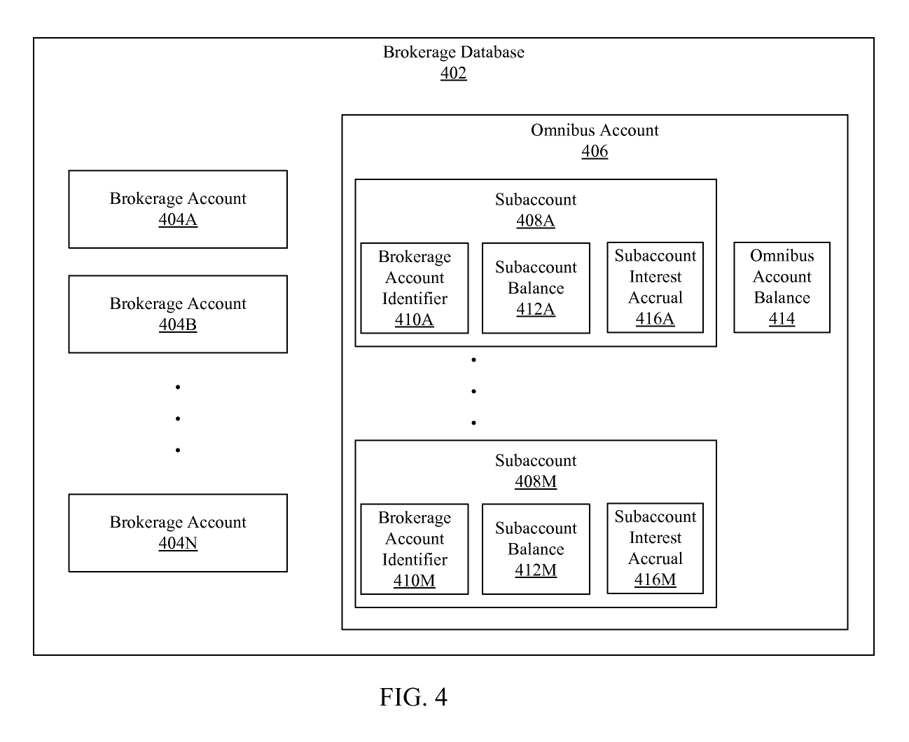

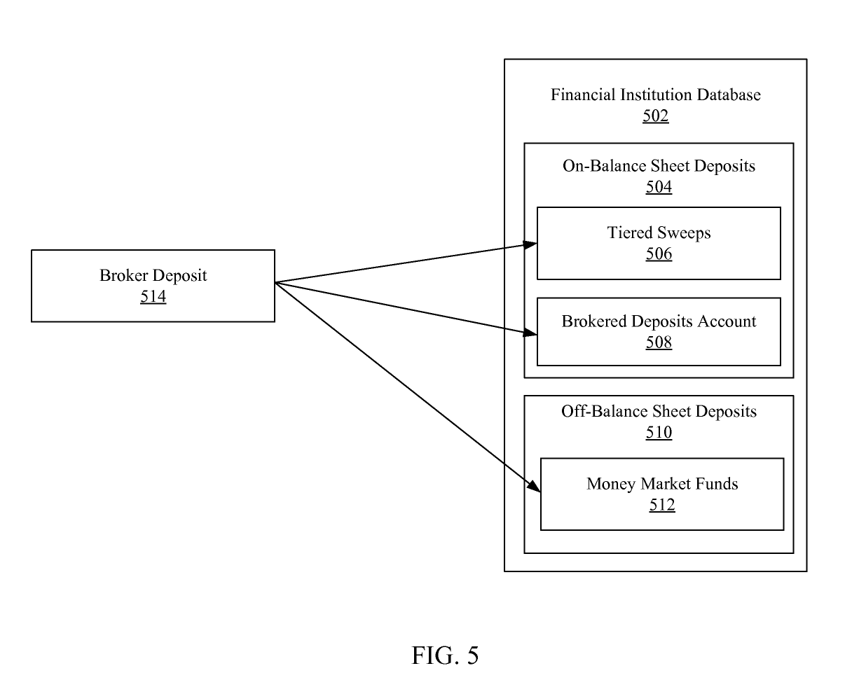

FIG. 3 illustrates an example signaling diagram of communications between the financial institution server 102, the broker server 104, and the customer computer 106. FIG. 4 illustrates an example of a brokerage database 402 implemented at the broker server 104 that stores brokerage accounts 404A-N and an omnibus account 406. FIG. 5 illustrates an example of a financial institution database 502 implemented by the financial institution server 102 that includes on-balance sheet deposits 504 and off-balance sheet deposits 510. The following refers to FIGS. 3-5.

Initially, with reference to numeral 302 in FIG. 3, one or more customer computers 106 may communicate a brokerage account setup request to establish a brokerage account with the broker server 104. The brokerage account setup request may include information about the customer, such as personal information (e.g., name, address, etc.), and may transfer monetary funds to a brokerage account 404. In response to receiving the brokerage account setup request, the broker server 104 may update its brokerage database 402 (see FIG. 4) to add a brokerage account 404 for the customer. In FIG. 4, for instance, the brokerage database 402 may include a brokerage account 404 storing information on each of its customers. The brokerage accounts 404A-N may include, for example, the personal information of the customer, information on the customer's holdings (e.g., stocks, bonds, etc.), and other brokerage information.

With reference to numeral 304 in FIG. 3, the broker server 104 may communicate with the financial institution server 102 to set up an omnibus account 406 for conducting ticketed transactions. The omnibus account 406 may consolidate transactions from its clients, and the financial institution server 102 may set up a brokered deposits account 508 to settle these transactions. The broker server 104 may transfer funds between the omnibus account 406 and the brokered deposits account 508 pursuant to customers' requests via their respective brokerage accounts 404. The omnibus account 406 may, for example, maintain records for a predetermined number of customers (e.g., 10,000), and keep track of each individual customer's balance and interest earned, etc.

With reference to numeral 306 in FIG. 3, one or more customer computers 106 may communicate a ticketed order request message to the broker server 104. The ticketed order request message may specify a monetary amount and a type of transaction (e.g., deposit, withdrawal, etc.).

In an illustrative embodiment, the customer computer 106 may access the broker server 104 to obtain a graphical user interface of the customer's brokerage account 404. Via the graphical user interface, the customer may trade stocks, bonds, hold alternative investments and buy/sell investments in the omnibus account 406 using their customer's brokerage account 404, as well as set up an interest bearing deposit account without having to separately set up the account directly with the financial institution.

To make a ticketed funds transfer, the graphical user interface may present a deposit product symbol of one or more omnibus accounts 406 for customer selection. The deposit product symbol may also identify an interest rate and yield for each of the omnibus accounts 406. The customer may select a deposit product symbol of a desired omnibus account 406, a type of transaction (e.g., deposit, withdrawal, etc.), and an amount. In response to the customer's selection, the customer computer 106 may generate and communicate a ticketed order request message to the broker server 104.

The broker server 104 may process the ticketed order request message to determine whether it is an initial request to invest in the omnibus account 406 or a subsequent order, the type of the transaction (e.g., withdrawal, deposit, etc.), and the amount. The broker server 104 may include rules on permitted deposit amounts for initial or subsequent orders. For example, the broker server 104 may require a minimum initial deposit (e.g., $100,000) and a minimal subsequent deposit ($1,000), a maximum balance (e.g., $100,000,000) and/or maximum order limit (e.g., $10,000,000 per trade), and may not execute a ticketed transfer if the customer exceeds one or more of the limits.

If the ticketed order request message does not comply with any applicable rules, the broker server 104 may communicate a reject message to the customer computer 106 indicating that the requested transaction cannot be completed. The reject message also may specify how the customer can remedy the rules violation.

Referring to FIG. 4, if the ticketed order request message is for an initial order that complies with any applicable rules, the broker server 104 may update the omnibus account 406 to establish a subaccount 408 in the omnibus account 406 for the customer. The broker server 104 may designate a subaccount 408 and provide the customer with an account number. Also, the subaccount 408 may be a logical designation where accounting tracks the monetary amount a particular customer has invested in the omnibus account 406. The subaccount 408 may include a brokerage account identifier 410, a subaccount balance 412, and a subaccount interest accrual 416. The brokerage account identifier 410 may identify the brokerage account 404 of the customer. The subaccount balance 412 may identify the amount of funds a customer is investing in the omnibus account 414, and the sum of the subaccount balances 412A-M may equal the omnibus account balance 414. In an example, the subaccount 408 may be a negotiable order of withdrawal (NOW) account, which may be an interest-earning bank account where the customer is permitted to write drafts against money held on deposit. Other types of savings accounts may be used as the subaccount, such as, but not limited to, a Money Market Deposit Account (MMDA) subaccount.

At predetermined settlement intervals (e.g., secondly, minutely, hourly, daily, weekly, etc.), the broker server 104 may aggregate the ticketed order request messages (e.g., deposits, withdrawals) received during the latest settlement interval to determine a net change in the omnibus account balance 414. For example, the broker server 104 may define a predetermined time each day (e.g., 5:00 PM) to execute all orders for that day, and any orders received thereafter may be executed on the following day. For ticketed deposits, the broker server 104 may debit the amounts specified in the ticketed order request messages from the customers' brokerage accounts 404 and credit the amounts to the omnibus account 406, and may update each subaccount balance 412 and brokerage account 404 to reflect the deposits. For ticketed withdrawals, prior to processing the withdrawal, the broker server 104 may determine whether multiple ticketed withdrawal requests have been received from a single customer during the latest settlement interval, and check to ensure that the total amount requested for withdrawal does not exceed the subaccount balance 412. If funds are sufficient, the broker server 104 may transfer funds from the omnibus account 406 to the respective brokerage accounts 404 after settling with the financial institution.

With reference to numeral 308 in FIG. 3, the broker server 104 may then communicate to the financial institution server 102 an aggregate payment order message identifying the net change in the omnibus account balance 414. The net change may be the sum of the ticketed deposits and withdrawals received during the latest settlement interval. For example, if three trade requests are received, where two are for deposits of $500 and $1,000, respectively, and one is for a withdrawal of $750, the net change in the omnibus account balance 414 would be an increase of $750. The financial institution server 102 may process the aggregate payment order message, and either receive payment from the financial institution server 102 if the net change is an increase, or transfer funds to the broker server 104 if the net change is a decrease.

With reference to numeral 310, the financial institution server 102 may communicate a confirmation message to the broker server 104 to indicate that the aggregate payment order message has been successfully processed. The broker server 104 may then transfer any withdrawals specified in the ticketed order request messages from the omnibus account 406 to the customers' brokerage accounts 404, and may update the subaccount balance 412 and the brokerage account 404 to reflect the withdrawals. With reference to numeral 312, the broker server 104 may communicate a status message to the customer computer 106 indicating that the ticketed transaction has been executed and/or to identify why the transaction could not be executed as requested.

The customers may thus directly make transfers of money to and from the omnibus account 406 for deposit with the financial institution, rather than having to take money out of their brokerage accounts 404 and separately open an account with the financial institution. This eliminates the account opening set-up process and allows the customers to access their money through their broker in the same way as other cash investments. Thus, the broker may act as an agent for a group of customers to conduct transactions with the financial institution using the omnibus account 406.

At interest rate time intervals (e.g., daily, weekly, etc.), the financial institution server 102 may calculate an interest rate for the funds in the omnibus account 406 during the latest time interval. With reference to numeral 314, the financial institution server 102 may communicate an interest rate message to inform the broker server 104 of the interest rate during the latest interval, and the interest may compound daily. For example, the financial institution server 102 may daily communicate an interest rate message indicating what the interest rate is for that day. For each subaccount 408, the broker server 104 may calculate an amount of accrued interest during the latest interval based on the interest rate, the subaccount balance 412, and the amount in the subaccount interest accrual 416. The broker server 104 may then update the subaccount interest accrual 416 for each subaccount 408A-M. For instance, if the interest rate time interval is one day, the broker server 104 may use the interest rate to determine the amount of interest accrued on the subaccount balance 412 and the subaccount interest accrual 416 for that day.

At distribution time intervals, the broker server 104 may then transfer the amount in each subaccount interest accrual 416 into the corresponding subaccount balance 412 and reset the subaccount interest accrual 416 to zero. As such, the accrued interest may be reinvested. The distribution time interval may refer the frequency that the accrued interest is added to the balance of the subaccounts 408. For example, the interest rate may change daily and the distribution time interval may be the first of each month. With reference to numeral 316 (see FIG. 3), the broker server 104 may communicate a status message to the customer computer 106 indicating that the interest has been distributed to their subaccount 408.

Tables 1-4, below, provide multiple examples of earning interest. In an example, when a customer makes a deposit, interest may begin accruing on the next business day after a deposit, and no interest may be accrued on the day funds are withdrawn. Tables 1 and 3 refer to interest being earned using the following methodology: interest earned today is based on yesterday's balance using yesterday's rate. Tables 2 and 4 refer to interest being earned using the following methodology: interest earned today on today's balance based using today's rate.

TABLE 1
Daily Interest Rate = 100 basis points

| Weekday Scenario | Monday | Tuesday | Wednesday |
|---|---|---|---|
| Activity | Deposit of $100 | No activity | Withdrawal of $100 |
| | before settlement | | before settlement |
| | cutoff time | | cutoff time |
| Daily Interest | $0.00 | $100*0.01 = $1.00 | $101*0.01 = $1.01 |
| Accrued | | | |
| Principal and Accrued | $100.00 | $101.00 | $0.0000 |
| Interest | | | |
| Free Credit Balance | N/A | N/A | $102.01 |

TABLE 2
Daily Interest Rate = 100 basis points

| Weekday Scenario | Monday | Tuesday | Wednesday |
|---|---|---|---|
| Activity | Deposit of $100 | No Activity | Withdrawal of $100 |
| | before settlement | | before settlement |
| | cutoff time | | cutoff time |
| Daily Interest | $100 × 0.01 = $1.00 | $101.00 × 0.01 = $1.01 | $0.00 |
| Accrued | | | |
| Principal and Accrued | $101.00 | $102.01 | $0.00 |
| Interest | | | |
| Free Credit Balance | N/A | N/A | $102.01 |

TABLE 3
Daily Interest Rate = 100 basis points

| Weekend Scenario | Thursday | Friday | Monday |
|---|---|---|---|
| Activity | Deposit of $100 | No Activity | Withdrawal of $100 |
| | before settlement | | before settlement |
| | cutoff time | | cutoff time |
| Daily Interest | $0.00 | $100 × 0.01 = $1.00 | $101.00 × (3*0.01) = $3.03 |
| Accrued | | | |
| Principal and Accrued | $100.00 | $101.00 | $0.00 |
| Interest | | | |
| Free Credit Balance | N/A | N/A | $104.03 |

TABLE 4
Daily Interest Rate = 100 basis points

| Weekend Scenario | Thursday | Friday | Monday |
|---|---|---|---|
| Activity | Deposit of $100 | No Activity | Withdrawal of $100 |
| | before settlement | | before settlement |
| | cutoff time | | cutoff time |
| Daily Interest | $100 × 0.01 = $1.00 | $101.00 × (3*0.01) = $3.03 | $0.00 |
| Accrued | | | |
| Principal and Accrued | $101.00 | $104.03 | $0.00 |
| Interest | | | |
| Free Credit Balance | N/A | N/A | $104.03 |

If a customer decides to withdraw some or all of the funds in their subaccount 408 prior to the distribution time interval, the broker server 104 may transfer the subaccount interest accrual 416 to the subaccount balance 412 as of the date when the request is received. The broker server 104 may transfer the updated subaccount balance 412 to the customer's brokerage account 404.

Making ticketed transactions through the omnibus account 406 has advantages for the customers and the financial institution. Referring to FIG. 5, deposits from brokers traditionally have been limited to tiered sweeps 506 and money market funds 512. Tiered sweeps 506 may be listed as on-balance sheet deposits 504, and money market funds 512 may be listed as off-balance sheet deposits 510. The on-balance sheet deposits 504 include the deposits on the balance sheet of the financial institution, and conversely, the off-balance sheet deposits are not listed on the balance sheet. The financial institution advantageously has greater flexibility with what they can do with the money in the on-balance sheet deposits 504, as compared to the off-balance sheet deposits 210. Even so, tiered sweeps 506 have not provided the financial institution with a liquidity value over a significant length of time, as brokers often daily transfer swept funds into and out of the financial institution.

The financial institution may benefit by accepting broker deposits 514 in the form of an aggregate payment order message 308, discussed above, by establishing the brokered deposits account 508 to take advantage of the liquidity value provided by brokered deposits received using the omnibus account 406, rather than establishing individual accounts with each customer. Because the financial institution is receiving a deposit from a broker, and not in a money market fund that is separately regulated, the financial institution may list the brokered deposits on its balance sheet.

To attract customers to invest their long-standing balances, the financial institution may provide a higher interest rate to invest using the omnibus account 406 as compared with money market funds. In money market funds, a financial institution is limited to paying for 90 days of liquidity value, regardless of how long a customer keeps their money in the fund. Because the length of time uninvested funds remain in a brokerage account 404 or in a sweep deposit often exceeds 90 days, the financial institution may determine the interest rate based on the average amount of time and an average amount of money that is deposited in the brokered deposits account 508. For example, the financial institution server 102 may determine that the average life of the average balance exceeds a predetermined number of time (e.g., four years). Because the length of time is longer than 90 days, the financial institution can make loans for up to that amount of time for the average balance.

The financial institution may benefit by gaining liquidity cheaper than non-deposit alternatives and may pass along some of the savings to the customers in the form of a yield that is superior to money market funds, yet does not require the customer to incur excessive investment risk. Thus the financial institution may obtain cheaper financial capital and may incentivize its customer to invest in this type of investment product. As such, the financial institution may increase its on-balance sheet deposits 504 using the omnibus account 406 and may pay a higher interest rate for customer deposits.

The customers may also obtain Federal Deposit Insurance Corporation (FDIC) insurance up to the standard maximum deposit insurance amount (SMDIA) for each ownership category if the financial institution is a bank or other entity that qualifies. Due to the broker server 104 associating the customers to the subaccounts 408, the broker server 104 may contain information to submit to the FDIC should the financial institution fail. For example, if the 10,000 customers invest in the omnibus account 406, in the event that the financial institution fails, the broker server 104 may use the information on the subaccounts 408 and the brokerage account identifier 410 to show account ownership for FDIC insurance purposes.

The above example embodiments describe a single financial institution. The broker may, however, set up multiple omnibus accounts, one for each financial institution. The customers may thus select one or more of the multiple financial institutions in which to deposit/withdraw their funds using the ticketed transfer process. Multiple financial institutions may also provide greater amounts of FDIC insurance as the customer may receive up to the SMDIA amount at each. If a deposit or interest payment would cause the subaccount balance 412 to exceed the SMDIA, the broker server 104 may deposit up to the SMDIA limit into a second financial institution using a second omnibus account.

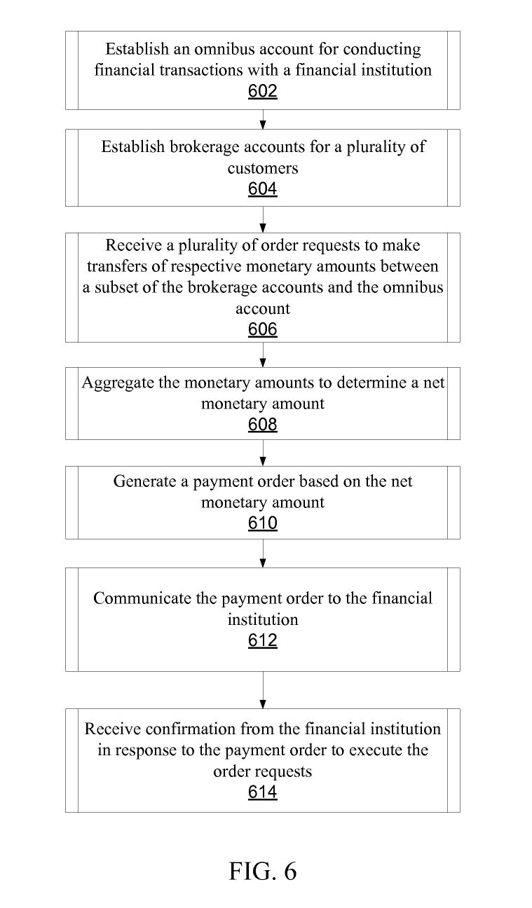

FIG. 6 illustrates an example method of processing a ticketed order request in accordance with example embodiments of the present disclosure. The example method may be implemented by the broker server 104 and may begin at block 602. In block 602, the method may include establishing an omnibus account for conducting financial transactions with a financial institution. In block 604, the method may include establishing brokerage accounts for a plurality of customers. In block 606, the method may include receiving a plurality of order requests to make transfers of respective monetary amounts between a subset of the brokerage accounts and the omnibus account. In block 608, the method may include aggregating the monetary amounts to determine a net monetary amount based on the order requests. In block 610, the method may include generating a payment order based on the net monetary amount. In block 612, the method may include communicating the payment order to the financial institution. In block 614, the method may include receiving confirmation from the financial institution in response to the payment order to execute the order requests. The method may then end.

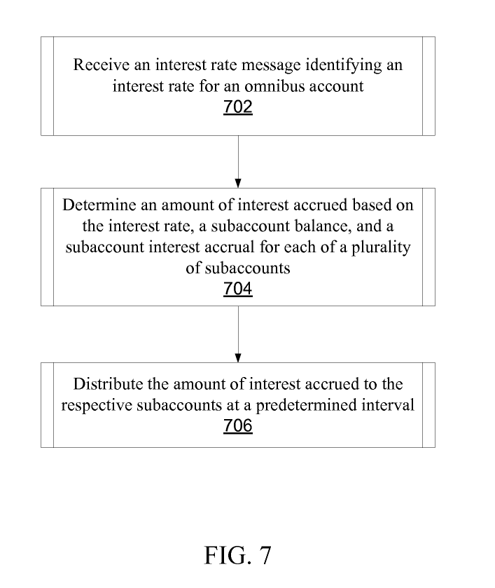

FIG. 7 illustrates an example method of allocating accrued interest to omnibus subaccounts in accordance with example embodiments of the present disclosure. The example method may be implemented by the broker server 104 and may begin at block 702. In block 702, the method may include receiving an interest rate message identifying an interest rate for an omnibus account. In block 704, the method may include determining an amount of interest accrued based on the interest rate, a subaccount balance, and a subaccount interest accrual for each of a plurality of subaccounts. In block 706, the method may include distributing the amount of interest accrued to the respective subaccounts at a predetermined interval. The method may then end.

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, and distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices. The computer-executable instructions may be stored on a computer readable media, such as, but not limited to, a hard disk, a floppy disk, a flash drive, or other tangible computer readable media and memories.

Aspects of the present disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the invention.

What is claimed is:

1. A method comprising:
establishing an omnibus account for conducting financial transactions with a financial institution;
establishing a brokerage account for each of a plurality of customers;
receiving a plurality of order requests to make transfers of respective customer-specified monetary amounts between a subset of the brokerage accounts and the omnibus account;
aggregating, by a processor, the monetary amounts to determine a net monetary amount based on the order requests;
generating a payment order based on the net monetary amount;
communicating the payment order to the financial institution; and
receiving confirmation from the financial institution in response to the payment order to execute the order requests.

2. The method of claim 1, further comprising allocating a subaccount in the omnibus account to each of the subset of brokerage accounts.

3. The method of claim 2, further comprising debiting or crediting the subaccounts based on the respective monetary amounts.

4. The method of claim 1, further comprising:
receiving an interest rate message identifying an interest rate for the omnibus account, wherein the omnibus account comprises a subaccount that corresponds to one of the subset of brokerage accounts;
determining an amount of interest accrued based on the interest rate, a subaccount balance, and a subaccount interest accrual for the subaccount; and
distributing, at a predetermined interval, the amount of interest accrued to the subaccount.

5. The method of claim 1, wherein at least one of the plurality of order requests comprises a withdrawal request that includes a withdrawal amount.

6. The method of claim 5, further comprising transferring the withdrawal amount from the omnibus account to a first of the brokerage accounts.

7. The method of claim 1, wherein at least one of the plurality of order requests comprises a deposit request that includes a deposit amount, the method further comprising transferring the deposit amount from a first of the brokerage accounts to the omnibus account.

8. An apparatus comprising:
a processor; and
a memory storing computer executable instructions that, when executed, cause the apparatus to perform operations comprising:
establishing an omnibus account for conducting financial transactions with a financial institution;
establishing a brokerage account for each of a plurality of customers;
receiving a plurality of order requests to make transfers of respective customer-specified monetary amounts between a subset of the brokerage accounts and the omnibus account;
aggregating, by a processor, the monetary amounts to determine a net monetary amount based on the order requests;
generating a payment order based on the net monetary amount;
communicating the payment order to the financial institution; and
receiving confirmation from the financial institution in response to the payment order to execute the order requests.

9. The apparatus of claim 8, wherein the computer executable instructions, when executed, cause the apparatus to allocate a subaccount in the omnibus account to each of the subset of brokerage accounts.

10. The apparatus of claim 9, wherein the computer executable instructions, when executed, cause the apparatus to debit or credit the subaccounts based on the respective monetary amounts.

11. The apparatus of claim 8, wherein the computer executable instructions, when executed, cause the apparatus to perform:
receiving an interest rate message identifying an interest rate for the omnibus account, wherein the omnibus account comprises a subaccount that corresponds to one of the subset of brokerage accounts;
determining an amount of interest accrued based on the interest rate, a subaccount balance, and a subaccount interest accrual for the subaccount; and
distributing, at a predetermined interval, the amount of interest accrued to the subaccount.

12. The apparatus of claim 8, wherein at least one of the plurality of order requests comprises a deposit request that includes a withdrawal amount.

13. The apparatus of claim 12, the method further comprising transferring the withdrawal amount from the omnibus account to a first of the brokerage accounts.

14. The apparatus of claim 8, wherein at least one of the plurality of order requests comprises a deposit request that includes a deposit amount, the method further comprising transferring the deposit amount from a first of the brokerage accounts to the omnibus account.

15. A computer readable medium storing computer executable instructions that, when executed, cause an apparatus to perform operations comprising:
establishing an omnibus account for conducting financial transactions with a financial institution;
establishing a brokerage account for each of a plurality of customers;
receiving a plurality of order requests to make transfers of respective customer-specified monetary amounts between a subset of the brokerage accounts and the omnibus account;
aggregating the monetary amounts to determine a net monetary amount based on the order requests;
generating a payment order based on the net monetary amount;
communicating the payment order to the financial institution; and
receiving confirmation from the financial institution in response to the payment order to execute the order requests.

16. The computer readable medium of claim 15, wherein the computer executable instructions, when executed, cause the apparatus to allocate a subaccount in the omnibus account to each of the subset of brokerage accounts.

17. The computer readable medium of claim 16, wherein the computer executable instructions, when executed, cause the apparatus to debit or credit the subaccounts based on the respective monetary amounts.

18. The computer readable medium of claim 15, wherein the computer executable instructions, when executed, cause the apparatus to perform:
receiving an interest rate message identifying an interest rate for the omnibus account, wherein the omnibus account comprises a subaccount that corresponds to one of the subset of brokerage accounts;
determining an amount of interest accrued based on the interest rate, a subaccount balance, and a subaccount interest accrual for the subaccount; and
distributing, at a predetermined interval, the amount of interest accrued to the subaccount.

19. The computer readable medium of claim 15, wherein at least one of the plurality of order requests comprises a withdrawal request that includes a withdrawal amount, the method further comprising transferring the withdrawal amount from the omnibus account to a first of the brokerage accounts.

20. The computer readable medium of claim 15, wherein at least one of the plurality of order requests comprises a deposit request that includes a deposit amount, the method further comprising transferring the deposit amount from a first of the brokerage accounts to the omnibus account.
